(19) United States
(12) Patent Application Publication
(10) Pub. No.: US 2009/0200147 A1
(43) Pub. Date: Aug. 13, 2009

(54) PUSH BUTTON SWITCH

(75) Inventor: Masashi WATANABE, Fujiyoshida-shi (JP)

Correspondence Address: BROWDY AND NEIMARK, P.L.L.C.;624 NINTH STREET, NW, SUITE 300, WASHINGTON, DC, 20001-5303, US

(73) Assignee: CITIZEN ELECTRONICS CO., LTD., Fujiyoshida-shi (JP)

(21) Appl. No.: 12/369,144

(22) Filed: Feb. 11, 2009

(30) Foreign Application Priority Data
Feb. 13, 2008 (JP) 2008-031660

(51) Int. Cl. H01H 5/18

(52) U.S. Cl. 200/406; 200/317

(57) ABSTRACT

A push button switch includes a base part provided with a fixed contact and a snap dome, a light source disposed on a lower surface of the base part, a cover member disposed to cover the base part and having at one side surface an opening, and an operating controller disposed to slide inside the opening in a lateral direction and configured to press the snap dome downwardly. The light source is contained in a cutout provided in a motherboard on which the push button switch is mounted, to illuminate the operating controller brightly.

### CROSS-REFERENCE TO THE RELATED APPLICATION

The application is based on and claims the priority benefit of Japanese Patent Application No. 2008-31660, filed on Feb. 13, 2008, the entire description of which is incorporated herein by reference.

### BACKGROUND OF THE INVENTION

1. Field of the Invention

The present invention relates to a push button switch, especially to a lateral-push button switch having an illumination function and used in small electronic equipment and devices such as mobile phones, portable game devices, digital cameras, mobile personal computers, and so on.

2. Description of the Related Art

A conventional general lateral-push button switch includes a circuit board provided with a fixed contact and a resilient snap dome as a base part, a cover member covering the base part of the push button switch and having at a peripheral side surface of the push button switch an opening, and an operating controller inserted in the opening to be disposed slidably in a lateral direction and configured to press the snap dome toward the fixed contact downwardly (for reference, see Japanese Patent Application Publication Nos. 2006-244977 and 2005-209565).

The base part includes a molded article in which a flat plate-like circuit board or lead frame is formed by insert molding, and the circuit board includes a plurality of solder pads which are provided on a lower surface of the circuit board and electrically connected to the fixed contact and the snap dome. The cover member includes a slope extending inward from an upper part of the cover member, and the slope is inclined to press the operating controller from obliquely above when the operating controller is laterally slid into the push button switch.

When the operating controller is pushed and laterally slid into the push button switch, a leading end portion or inner end portion of the operating controller is downwardly guided and pressed from obliquely above by the slope, and the snap dome comes into contact with the fixed contact.

In this way, by sliding the operating controller in a lateral direction, the snap dome with the fixed contact is configured to execute switch-on and-off operations.

In the push button switch having the aforementioned structure, the cover member is fixed to the base part to cover the snap dome and the fixed contact. The push button switch, when used in an electronic device, is mounted on a motherboard of the electronic device by bonding the base part onto the motherboard directly through soldering.

Because thinning is required in small electronic devices in each of which a push button switch is surface-mounted on a motherboard of the electronic devices, the push button switch is also required to be thin. When the push button switch is surface-mounted on an electronic device, the fixation and the electrical connection of the push button switch to the motherboard of the small electronic equipment are simultaneously executed by a reflow process.

In addition, there are proposed push button switches each including a light source illuminating a push-button part of the push button switch to enhance visibility or operability. The light source includes, for example, at least one light-emitting diode (LED) element that is disposed on an upper surface of the base part, provided with the push button switch, or in a side of the motherboard on which the push button switch is mounted.

However, in the lateral-push button switch having the aforementioned structure, because a user's pushing force on the operating controller that is pressed against the slope of the cover member accompanies performance of the switch-on and-off operations of the snap dome and the fixed contact, it is necessary to increase the strength of the cover member to a certain extent relative to the base part provided with the snap dome and the fixed contact or a motherboard on which the push button switch is finally mounted in an electronic device. In addition, the lateral-push button switch is often installed in small electronic devices such as mobile phones, portable game devices, digital cameras, mobile personal computers and so on as a lateral-push button switch provided at a side surface of the electronic device. However, because a user carries around a mobile phone and other small electronic devices as portable devices, it often happens that the small electronic devices are accidentally dropped or hit on an object, and strong impacts and large stresses often cause problems in the switch function of the push button switch or physical destruction.

In most cases the destruction begins first from a side surface of a cover member, the side surface facing a sliding direction of the operating controller, and thereafter reaches the base part provided with the snap dome and the fixed contact. When the light source for illumination is disposed on the upper surface of the base part, there is a possibility that destruction and deteriorated function of the light source may occur due to an external impact force. Therefore it is necessary to particularly increase strength of a portion of the push button switch close to a switch operation part exposed on a side surface of the mobile phone and other electronic devices.

Furthermore, because the push button switch is finally surface-mounted on the motherboard of an electronic device, it is often bonded by solder in a reflow process. In the reflow process, joint strength tends to increase in proportion to a size of solder-joining area. Therefore, a process of securing a large solder-joining area of the base part of the push button switch to the motherboard has conventionally been executed. However, if the solder-joining area of the circuit board becomes larger, for example, the circuit board and the push button switch become larger which goes against the requirement for thinner and smaller push button switches to be mounted in small electronic devices such as mobile phones and other portable electronic devices. Also, if the base part is formed by inserting a lead frame, it is not easy to ensure a large solder-joining area, because a size of electrodes is previously determined.

Furthermore, if a push button switch including a light source is used, there is a problem that it is difficult to miniaturize the entire switch, because a space for disposing a light source must be ensured.

### SUMMARY OF THE INVENTION

An object of the present invention is to provide a push button switch capable of being miniaturized and easily operated with an illumination function and a push button switch that is impact resistant, prevented from being destroyed and becoming detached from a motherboard even if a large impact due to dropping or hitting is applied to an electronic device in which the push button switch is disposed.

To accomplish the above object, a push button switch according to one embodiment of the present invention includes a base part, a fixed contact provided on the base part, a snap dome provided on the base part to cover the fixed contact, a cover member disposed to cover at least one portion of the base part, a light source disposed on a lower surface of the base part, and an operating controller disposed in the base under the cover member and configured to perform switch-on and-off operations of electrical connection between the snap dome and the fixed contact.

The cover member includes a pair of side extended portions extending downwardly along sides of the base part, and extensions extending laterally along a same level of the lower surface of the base part.

The base part includes at the lower surface thereof at least a pair of solder pad portions electrically connected to the snap dome and the fixed contact.

The light source is configured to illuminate the operating controller and/or to achieve the illumination for decoration.

### BRIEF DESCRIPTION OF THE DRAWINGS

FIG. 1 is a perspective view of a push button switch according to one embodiment of the present invention, as viewed from below.

FIG. 2 is a perspective view of the push button switch, as viewed from above.

FIG. 3 is a side view of the push button switch, as viewed from an operating side of the push button switch.

FIG. 4 is a bottom view showing a state where the push button switch is mounted on a motherboard of an electronic device.

FIG. 5 is a sectional view taken along line V-V in FIG. 2 in a state where the push button switch is not operated.

FIG. 6 is an exploded perspective view of the push button switch.

FIG. 7 is an operative view showing a state of a usual switch-on operation in the push button switch.

FIG. 8 is an operative view showing a state in which a large external lateral force is applied to a push button switch.

### DETAILED DESCRIPTION OF THE PREFERRED EMBODIMENTS

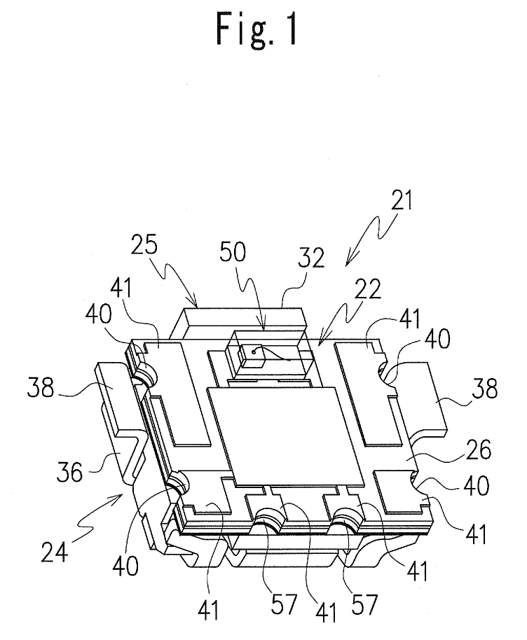

FIGS. 1 to 5 illustrate a push button switch 21 having an illumination function according to one embodiment of the present invention.

FIG. 3 shows the push button switch 21 mounted on a motherboard 20 of an electronic device.

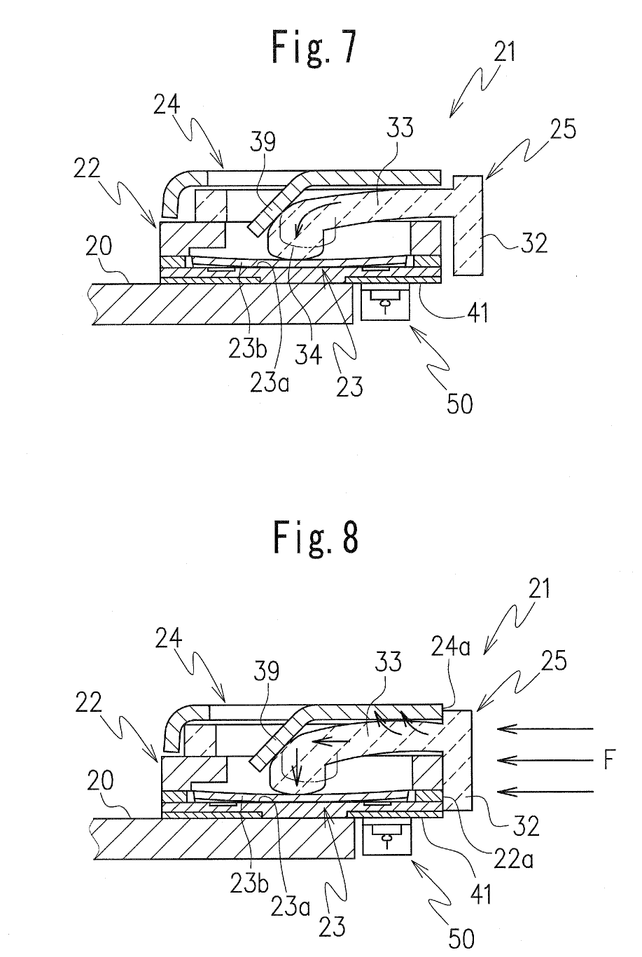

The push button switch 21 includes, as a base part 22, a circuit board 26, a fixed contact 23a disposed on an upper surface of the circuit board 26, and a snap dome 23b elastically disposed on the upper surface of the circuit board 26 over the fixed contact 23a, and a cover member 24 disposed to cover the base part 22, the push button switch 21 having an opening at a side surface of the push button switch between the cover member 24 and the base part 22, an operating controller 25 that is inserted in the opening and slidably disposed above the base part 22 under the cover member 24, and a light source 50 illuminating a pressed operation side of the operating controller 25. The operating controller 25 is slidably disposed inside the push button switch 21 and configured to press at an inner end of the operating controller 25 the snap dome 23b from above, resulting in an electrical connection between the fixed contact 23a and the snap dome 23b (see FIGS. 5 and 7).

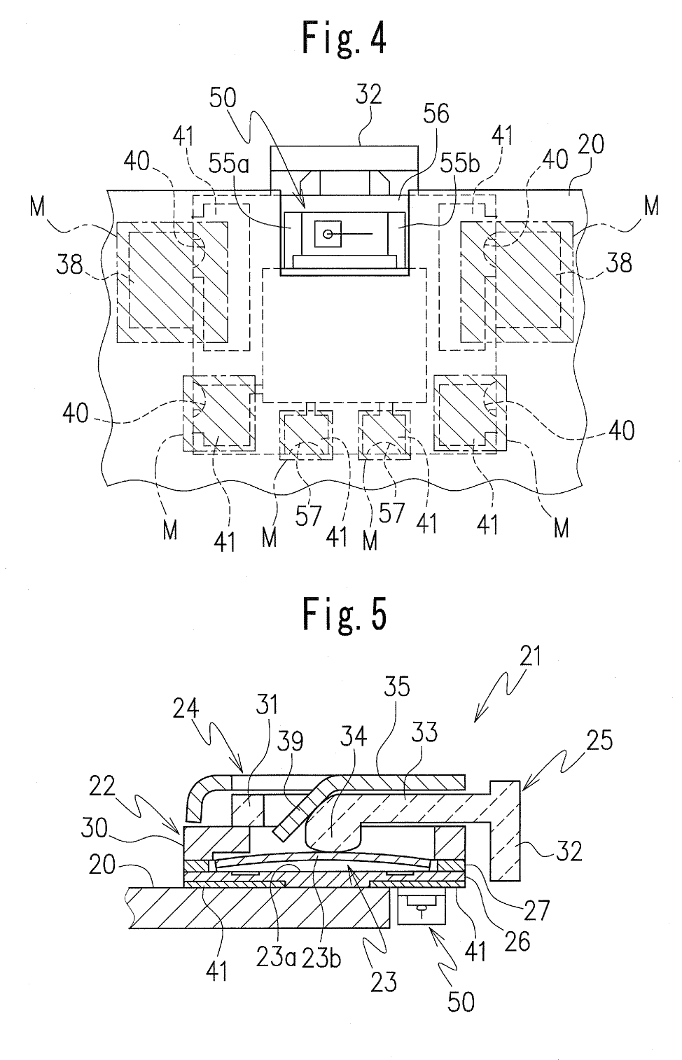

The push button switch 21 includes at a lower surface of the base part 22 a predetermined mounting area, for example, square mounting portions M (see FIG. 4), each of which includes, for example, a pair of electrodes 40 and solder pad portions 41 provided on the lower surface of the circuit board 26, and two pairs of the solder pad portions 41 disposed on front and back portions of right and left sides, and a back end of the base part 22.

The front two solder pad portions 41 are adjacently disposed to lower surfaces of extensions 38 of the cover member 24, respectively. The electrodes 40 and the solder pad portions 41 will be described hereinafter in further detail.

The operating controller 25 includes a push-button part 32 that receives a lateral pressing force to move the operating controller 25 laterally in the push button switch 21 to make an electrical connection of the switch unit 23. The light source 50 is disposed on the base part 22 to illuminate the operating controller 25 or around it, for example, at least the push-button part 32 of the operating controller 25 to perform securely an operation of the operating controller 25.

When the push button switch 21 is used in an electronic device such as a mobile phone, the circuit board 26 of the push button switch 21 is electrically mounted on a motherboard 20 of the electronic device, and the push-button part 32 of the push button switch 21 is disposed at an outside surface of a housing of an electronic equipment, so that a user can push the push-button part 32. The push-button part 32 may be disposed to appear at a side surface of the housing of the electronic device when the push button switch is mounted in the electronic device. The snap dome 23b and the fixed contact 23a are electrically connected or disconnected in accordance with movements of the operating controller 25 (see FIGS. 5 and 7). When the operating controller 25 presses the snap dome 23b from above, the snap dome 23b is pressed to be in contact with the fixed contact 23a, and when the push-button part 32 of the operating controller 25 is released, the snap dome 23b is released and resiliently returns to an original position that is electrically disconnected from the fixed contact 23a.

The light source 50 is provided on the lower surface of the base part 22, as shown in FIGS. 1, 3 and 4 and disposed close to the push-button part 32. The light source 50 includes a rectangular substrate 51 bonded to the base part 22, a light-emitting element 52 mounted on the substrate 51, and a resin member 54 sealing the light-emitting element 52 on the substrate 51. The light-emitting element 52 comprises at least one LED element including a pair of anode and cathode electrodes and emits emission colors such as blue, red colors and so on through application of a voltage. The pair of anode and cathode electrodes are electrically connected to electrodes 55a and 55b patterned on the substrate 51 through die-bonding and wire-bonding or bumps, respectively (see FIG. 4).

The resin member 54 is made of a light-transmitting resin material such as a transparent or translucent resin material to transmit light emitted from the LED element 52 and formed on the substrate 51 by use of a mold or the like. A thinly colored material of a color such as milky-white or the like may be used for the light-transmitting resin material depending on an object or use of illumination or decorative effect. The light source 50 having the aforementioned structure is disposed between the front solder pad portions 41 in a position adjacent to the opening 42 formed in the front side of the cover member 24.

The push button switch 21 is fixed to the motherboard 20 by bonding the solder pad portions 41 of the base part 22 and the extensions 38 of the cover member 24 to the motherboard 20 through solder. The light source 50 is contained in a cutout 56 provided in a front end of the motherboard 20 (see FIG. 3).

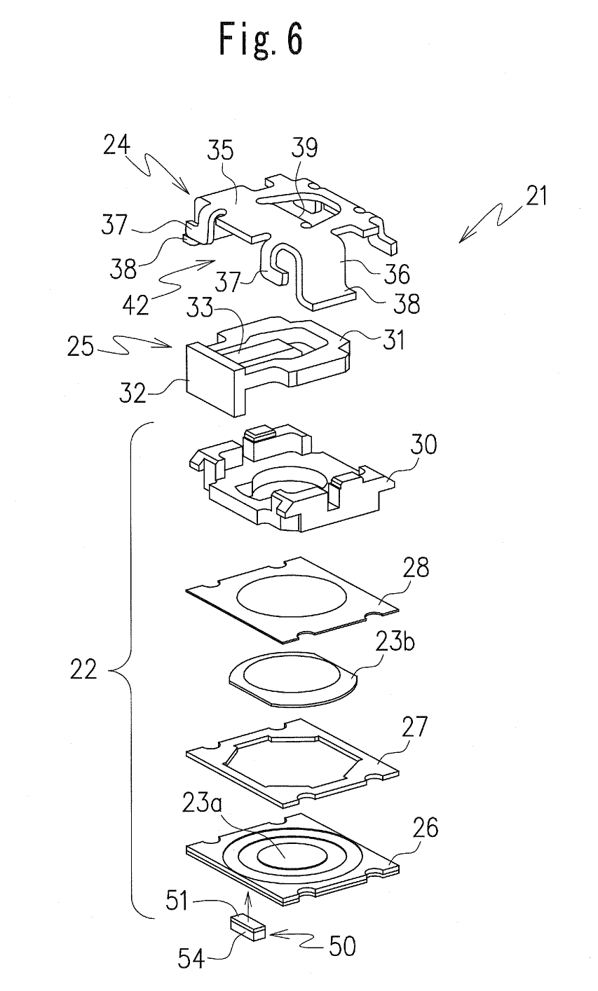

FIG. 6 illustrates an exploded perspective view of a push button switch 21 according to an embodiment of the present invention. The base part 22 includes a circuit board 26 which has, for example, a substantially square shape and is provided with a fixed contact 23a having, for example, a circular shape, a base sheet 27, which has a substantially annular shape, disposed on a peripheral portion of the upper surface of the circuit board 26, with the fixed contact 23a being disposed in a center of the circuit board 26, a resilient snap dome 23b having a generally dome-like shape and being disposed on the upper surface of the circuit board 26 over the fixed contact 23a and the snap dome 23b at a center thereof disposed vertically away from the fixed contact 23a as an initial position (see FIG. 5), a water-proof protection sheet 28 covering the snap dome 23b, and a mold frame 30 adhesively fixed to the water-proof protection sheet 28 and including a vertically passing hole and a concave portion to receive an operating controller 25 from a lateral direction.

The light source 50 including the resin member 54 is fixed to the lower surface of the circuit board 26 and disposed downwardly.

Meanwhile, when the operating controller 25 is not operated, the snap dome 23b is disposed away from the fixed contact 23a by a predetermined distance (see FIG. 5).

The circuit board 26 is made of resin, glass epoxy, for example, and provided with wiring patterns disposed on the upper surface of the circuit board 26 and electrically connected to the snap dome 23b and the fixed contact 23a. The electrodes 40 provided on the circuit board 26 includes at least two through-hole electrodes electrically connected to the wiring patterns, the through-hole electrodes 40 being disposed at a peripheral side surface of the circuit board 26 and extending from the upper surface to the lower surface of the circuit board (see FIGS. 1 and 4). In the illustrated embodiment, four through-hole electrodes 40 are provided adjacent to four corners of the circuit board 26.

In addition, a pair of electrode terminals 57 electrically connected to the electrodes 55a and 55b of the light source 50 through wiring patterns are provided on one end of the lower surface of the circuit board 26 below the opening 42. In this embodiment, the electrode terminals include the through-hole electrodes 40, respectively.

The aforementioned solder pad portions 41 are provided on the lower surface of the circuit board 26 and configured to mount the through-hole electrodes 40 and the electrode terminals 57 on electrode patterns formed on the motherboard 20 (see FIGS. 1, 3 and 4).

The solder pad portions 41 are formed, for example, by applying metallic plating on the lower surface of the circuit board 26 and some of the solder pad portions 41 are disposed adjacent to at least two lower surfaces of extensions 38 of the covering member 24 that are extended to a same level of the lower surface of the circuit board 26 or the solder pad portions 41. The two solder pad portions 41 and adjacently disposed two lower surfaces of the extensions 38 of the cover member 24 are two solder-pad-portion-extension-connecting mounting portions M that are fixed to a motherboard of an electronic device when the push button switch 21 is mounted in the electronic device. In addition, other two solder pad portions 41 can be fixed to the motherboard 20 and may be used for electrical connection to the motherboard 20. The push button part 32 may be disposed to appear at an outer side surface of the case, which belongs to the electronic device, and therefore, a user can press the push button part 32 from outside of the electronic device. Also, the light source 50 may be disposed below the push button part 32.

The snap dome 23b is, for example, an electrically conductive plate-like spring or a dome-like spring and is formed by a thin resilient plate of a metallic material such as stainless steel (SUS), brass, and so on. The snap dome 23b has a central portion which comes into contact with the fixed contact 23a, when being pressed by the operating controller from above. The operating controller 25 is laterally slid into the inside of the push button switch and an inner end of the operating controller 25 is pressed from above by a part of the cover member 24, when the push-button part 32 of the controller 25 is pressed. In a usual state, the snap dome 23b is disposed in an upwardly slightly inflated dome-like shape so as not to be in contact with the fixed contact 23a and positioned at a central portion of the circuit board 26 by the base sheet 27 (see FIG. 5).

The operating controller 25 includes a plunger 31 and a press stick 33 that laterally extend from an inner surface of the push-button part 32 and are disposed in the concave portion of the mold frame 30 of the base part 22. Even if the plunger 31 and the press stick 33 are contained in the mold frame 30, the push-button part 32 is disposed outside the mold frame 30. The press stick 33 laterally extends from a central part of the inner surface of the push-button part 32, and the press stick 33 has a free end portion at the inner end of the press stick 33. The free end portion of the press stick 33 is provided with a pressing portion, for example, a protrusion 34 which is positioned above a top of the snap dome 23b at a generally central portion of the base part 22 of the push button switch (see FIG. 5).

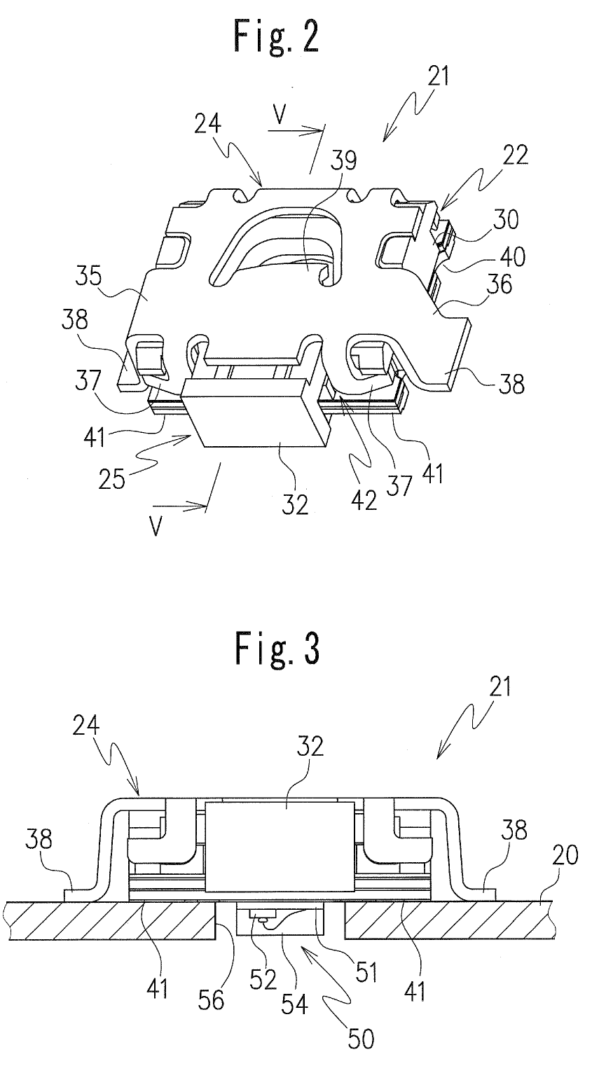

The cover member 24 is configured to cover the plunger 31, the press stick 33, and the mold frame 30 and the cover member 24 has at least two portions downwardly extended around side surfaces of the base part 22 to a level of the lower surface of the circuit board 26. The side downwardly extended portions of the cover member 24 at downward ends thereof may have extensions 38 laterally extended along the level of the lower surface of the circuit board 26. The cover member 24 includes an opening 42 into which the plunger 31 is inserted, a top panel portion 35 covering the plunger 31, side extended portions 36 configured to extend downwardly from opposite sides of the top panel portion 35 to the circuit board 26 across the operating controller 25, a plurality of engaging portions 37 that extend downwardly and engage with the mold frame 30, and extensions 38 which extend approximately laterally from lower ends of the side extended portions 36, laterally outward away from the circuit board 26 (see FIGS. 2 and 6).

The cover member 24 is formed by, for example, punching and/or folding one metallic plate. The top panel portion 35 includes a slope 39 that extends toward inside the push button switch away from a part of the top panel portion 35 and the slope 39 is inclined toward inside a central portion of the push button switch to be in contact with an upper surface of the protrusion 34 of the press stick 33 that is a part of the operating controller 25 (see FIG. 5). The slope 39 is configured to press the protrusion 34 of an inner open end of the press stick 33 of the plunger 31 toward the snap dome 23b which is disposed downwardly, when the plunger 31 is laterally pressed into the mold frame 30 by pressing the push button part 32 to electrically connect the snap dome 23b and the fixed contact 23a (see FIG. 7). In the embodiment, a surface of the protrusion 34 of the pressing section 32, contacting with the slope 39, has an inclined surface along the slope 39 (see FIG. 3).

In the aforementioned push button switch 21, the base part 22 is placed on the motherboard 20 and the four solder pad portions 41 are bonded to a predetermined mounting area of the motherboard 20 by soldering through a reflow process. At this time, the light source 50 is contained in a cutout 56 provided in a front end portion of the motherboard 20.

In a lateral-push button switch 21 having the aforementioned structure, the most important features of the present invention are that the extensions 38 of the cover member 24 are disposed adjacent to some of the solder pad portions 41 formed at a lower surface of the circuit board 26, the side extended portions 36 and extensions 38 of the cover member 24 are positioned across a sliding direction of the operating controller 25, and the light source 50 is disposed to illuminate at least the push-button part 32 of the operating controller 25, as shown in FIGS. 1 and 4. The extensions 38 may be disposed near the side where the push-button part 32 of the operating controller 25 is disposed. In addition, lower surfaces of the extensions 38 of the side extended portions of the cover member 24 are in a same plane as that of the circuit board 26 or that of each of the solder pad portions 41.

In this way, by disposing the extensions 38 of the cover member 24 adjacent to some of the solder pad portions 41 of the base part 22, the extensions 38 and the adjacent solder pad portions 41 can be firmly bonded together as mounting portions M to the motherboard 20 simultaneously, and thus the cover member 24 or the base part 22 can be prevented from easily falling or becoming detached from the motherboard 20 even if a large external force is applied to the push button switch 21. In addition, by illuminating the operating controller 25 with the light source 50, it is possible for a user to recognize and operate securely the operating controller 25.

An operational effect of the push button switch 21 having the aforementioned structure in the case of a usual switch-on operation and where a large impact is applied is described hereinafter with reference to FIGS. 5, 7 and 8. Here, FIG. 5 illustrates a state where the snap dome 23b and the fixed contact 23a are not electrically connected, and FIG. 7 illustrates a state where the snap dome 23b and the fixed contact 23a are electrically connected. FIGS. 5 and 7 illustrate states in a usual switch operation. On the other hand, FIG. 8 illustrates in section a state where a large external force is applied to the push button switch 21 from an operation side, in other words, the side of the push button part of the operating controller, when the electronic device in which the push button switch 21 is mounted is dropped.

As shown in FIG. 5, in a state where the operating controller 25 is not pressed toward the snap dome 23b and the fixed contact 23a, the leading end portion of the press stick 33 abuts with the slope 39 of the cover member 24, but because the snap dome 23b is not pressed, an external force is not applied to either of the base part 22 or the cover member 24. From this state, when the push-button part 32 of the operating controller 25 is pressed, as shown in FIG. 7, the protrusion 34 of the leading portion of the operating controller 25 descends along the slope 39 provided on the cover member 24 to press the resilient snap dome 23b down toward the fixed contact 23a against the resilience of the snap dome 23b.

By this operation, a reaction force from the snap dome 23b is imparted to the cover member 24, but because the cover member 24 is bonded at the extensions 38 of the cover member 24 onto the motherboard 20, a usual switch-on operation of the snap dome 23b and the fixed contact 23a can be achieved stably. Even when the push-button part 32 of the operating controller 25 is released, the switch-off operation between the snap dome 23b and the fixed contact 23a can similarly be accomplished stably.

Because an adjacent position of the operating controller 25 can be illuminated by light emitted from the light source 50, the operation of the operating controller 25 in a dark place or at night is simplified. Meanwhile, if the push button switch 21 according to the present invention is used as a side-surface switch in mobile phones or portable electronic devices, it is possible to make the light source 50 be lighted when opening a cover of a receiver of the mobile phone for a call or operating the side-surface switch separately.

In a case of accidentally dropping or hitting of an electronic device in which the push button switch 21 is mounted, if an excessively large external force which is more than a pressing force due to usual switch-on and-off operations is applied to the push-button part 32, a part of an inner surface of the push-button part 32 collides with a side portion 22a of the base part 22 or an edge portion 24a of the cover member 24, as shown in FIG. 8. In the bonding structure of the aforementioned conventional push button switches, if such a large laterally pressing force F (see FIG. 8) is applied to the conventional push button switch, the base part, the cover member and the portions fixed to the motherboard receive a large stress, and consequently, the conventional push button switch tends to become detached from the motherboard, and the light source 50 may be destroyed.

This is the reason that bonded positions of the base part and the cover member to the motherboard come loose, and therefore an impact force due to the external force F concentrates at either one of the base part or the cover member, in the conventional push button switch.

However, in the push button switch 21 according to the present invention, as mentioned above, the extensions 38 of the cover member 24 are provided adjacent to some of the solder pad portions 41 of the base part 22 and further the extensions 38 are bonded to the mounting area of the motherboard 20 by soldering, together with the solder pad portions 41. Accordingly, if the excessive external force F is applied to the push button switch 21 from the direction as shown in FIG. 8, the external force is received and supported by the entirety of mounting portions M. In particular, because in some of the mounting portions M, each have a combined planar space of a solder pad portion 41 and an extension 38, it is possible to set the amount of solder applied to a large value and stably maintain a high mechanical bonding intensity.

As shown in FIGS. 3 and 4, by positioning the extensions 38 in the direction perpendicular to the sliding direction of the operating controller 25, a large external force which may be applied to the push button switch 21 through the push-button part 32 can be supported by the extensions 38 extending in a direction across a sliding direction of the operating controller 25, thus preventing excessive pressures on the cover member 24 and the base part 22 from leading a breakage of the switch due to detachment from the motherboard 20, and so on.

Moreover, by bonding the extensions 38 extending from the edges of the side portions of the cover member 24 and some of the solder pad portions together as mounting portions M soldered on a motherboard, the bonding positions of the cover member 24 and the base part 22 are aligned, and thus the cover member 24 and the base part 22 are bonded with higher intensity to the motherboard 20. Consequently, it is possible for the push button switch 21 to maintain sufficient bonding intensity with connected and extended bonding areas, even if each of the extensions 38 have some small area for bonding portions.

Furthermore, it is possible to mount a push button switch according to the present invention in a limited area of a motherboard 20, and therefore mobile phones and other small electronic devices can be miniaturized or thinned.

In the illustrated embodiment, to increase intensity of fixation, the extensions 38 provided on the cover member 24 are configured to be disposed adjacent to the pair of solder pad portions 41 provided at a lower surface of the base part 22 near the push button part 32. If such a push button switch 21 is structured to have an even greater intensity of fixation, the cover member 24 can be configured to provide additional extensions 38 which are disposed adjacent to the solder pad portions 41 of the pair of right and left through-hole electrodes 40 provided on a lower side of the base part 22, in addition to the extensions 38 disposed adjacent to the solder pad portions 41 of the pair of LED electrode terminals 57 disposed on the lower surface of the base part 22.

In the push button switch 21 according to the present invention, because the solder pad portions 41 provided on the lower surface of the base part 22 and extensions 38 of the cover member 24 covering the base part 22 are disposed adjacently, it is possible to bond one of the solder pad portions 41 and one of the extensions 38 by soldering together as connected mounting portions M when the push button switch is mounted on a motherboard. Consequently, stronger bonding of the solder pad portions 41 and the extensions 38 can be accomplished to prevent the base part 22 and the cover member 24 from easily being separated from the motherboard, even if a large external force such as dropping or the like is applied to the operating controller 25.

Because the switch parts and the operating controller are collectively disposed on the upper surface of the base part, and the pair of solder pad portions and the light source are disposed on the lower surface of the base part, it is possible to provide a push button switch having the function of illuminating the operated side of the operating controller brightly and capable of accomplishing the miniaturization and the reduced mounted space of the base part.

Also, because the light source is disposed between the pair of solder pad portions provided on the lower surface of the base part, and the extensions of the cover member are provided adjacent to the solder pad portions, the solder pad portions and adjacently disposed extensions can be fixed simultaneously, respectively fixed to corresponding mounting areas of the motherboard or a place to be mounted by soldering. Accordingly, stronger bonding of the solder pad portions and the extensions can be accomplished to prevent the base part and the cover member from easily being separated from the motherboard, and to prevent the light source from suffering great damage to thus maintain the illumination function over a long period, even if a large external force such as dropping or the like is applied to the operating controller.

In addition, because the light source is disposed adjacent to the opening in which the operating controller is slidably moved, the side of the operating controller, in particular, can be brightly illuminated.

Furthermore, the light source is provided on the lower surface of the base part and the resin material protruding from the lower surface is contained in the cutout provided in the motherboard, a planar space of the base part is reduced, and thus, accomplishing miniaturization of the entire push button switch.

In addition, because the extensions 38 and some of the solder pad portions 41 are bonded to a motherboard as connected mounting portions M respectively, the extensions 38 have sufficient bonding strength even if the extensions 38 each have a small area. Consequently, it is possible to keep a mounting space of the push button switch 21 small in an electronic device, while the push button switch becomes impact-resistant.

As mentioned above, because the lower surfaces of the extensions of the cover member 24 are bonded to a motherboard by soldering together with the adjacent solder pad portions 41, it is possible to easily bond the extensions of the cover member 24 and the solder pad portions of the circuit board 26 of the base part 22 to a motherboard through a reflow process by previously applying solder plating to the lower surfaces of the extensions of the cover member 24 and the solder pad portions 41 of the circuit board 26.

Although the preferred embodiments of the present invention have been described, it should be understood that the present invention is not limited to these embodiments, and that various modifications and changes can be made to the embodiments.

For example, in the push button switch 21 in the aforementioned embodiment, the base part 22 includes a combination of the circuit board 26 made of epoxy resin and the mold frame 30 in which the snap dome 23b, the fixed contact 23a, and the operating controller 25 are contained, but the circuit board 26 may be replaced by a lead frame including external connecting terminals.

In this case, the push button switch 21 is structured by using a molded base part, which may be formed by inserting the lead frame.

A push button switch using the molded base part formed on the lead frame has a bonding strength, that achieves similar effect of that of push button switches in embodiments of the present invention, by providing a cover member including extensions disposed adjacent to portions corresponding to the exterior connecting terminals of the lead frame.

What is claimed is:

1. A push button switch, comprising:
a base part;
a fixed contact provided on the base part;
a snap dome provided on the base part to cover the fixed contact;
a cover member disposed to cover at least one portion of the base part;
a light source disposed on a lower surface of the base part; and
an operating controller disposed in the base part under the cover member and configured to perform switch-on and-off operations of electrical connection between the snap dome and the fixed contact,
the cover member including a pair of side extended portions extending downwardly along sides of the base part, and extensions extending laterally along a same level of the lower surface of the base part,
the base part including at the lower surface thereof at least a pair of solder pad portions electrically connected to the snap dome and the fixed contact.

2. The push button switch according to claim 1,
wherein the cover member includes an opening to insert the operating controller slidably.

3. The push button switch according to claim 2,
wherein the opening is provided in at least one side surface of the cover member.

4. The push button switch according to claim 1,
wherein the light source includes a light-emitting element and a resin material sealing the light-emitting element.

5. The push button switch according to claim 2,
wherein the light source is disposed adjacent to the opening provided in the cover member.

6. The push button switch according to claim 2,
wherein the light source is contained in a cutout provided in a motherboard on which the push button switch is mounted and configured to illuminate about the opening.

7. The push button switch according to claim 2,
wherein the operating controller includes a press stick and is configured to be slid in a lateral direction to press the snap dome downwardly.

8. The push button switch according to claim 1,
wherein each of the extensions of the cover member includes a lower surface extending in a same plane as a lower surface of each of at least a pair of the solder pad portions.

9. The push button switch according to claim 1,
wherein the solder pad portions provided on the lower surface of the base part are positioned at both sides of the opening in which the operating controller is inserted.

10. The push button switch according to claim 1,
wherein the extensions of the cover member are disposed adjacent to some of the solder pad portions respectively.

11. An electronic device, comprising:
the push button switch as recited in claim 1; and
a motherboard on which the push button switch is mounted,
the push button switch being electrically connected to the motherboard and fixed to the motherboard at the extensions and the solder pad portions.

12. The electronic device according to claim 11,
wherein the extensions are fixed to the motherboard by soldering.

13. The electronic device according to claim 11,
wherein the extensions and the solder pad portions adjacent to the extensions are fixed together to the motherboard by soldering.

14. An electronic device, comprising:
at least one push button switch each comprising a base part, a fixed contact provided on the base part, a snap dome provided on the base part to cover the fixed contact, a cover member disposed to cover at least one portion of the base part, a light source disposed on a lower surface of the base part, an operating controller disposed in the base part under the cover member and configured to perform switch-on and-off operations of electrical connection between the snap dome and the fixed contact, the cover member including a pair of side extended portions extending downwardly along sides of the base part, and extensions extending laterally along a same level of the lower surface of the base part and disposed adjacent to some of the solder pad portions respectively, and the base part including at least a pair of solder pad portions at the lower surface of the base part;
a motherboard to which the solder pad portions and the extensions of the cover member bonded; and
a case containing the at least one push button switch and the motherboard.

15. The electronic device according to claim 14,
the operating controller of the push button switch further including a push button part, and the push button part is disposed at an outer surface of the case.

16. The electronic device according to claim 15,
wherein the light source is disposed below the push button part adjacent to the outer surface of the case.
